(19) United States
(12) Patent Application Publication
(10) Pub. No.: US 2014/0006811 A1
(43) Pub. Date: Jan. 2, 2014

(54) POWER SUPPLY CIRCUIT FOR HARD DISK BACKPLANE AND SERVER SYSTEM USING SAME

(71) Applicants: Hon Hai Precision Industry Co., Ltd., New Taipei (TW); Hong Fu Jin Precision Industry (Shenzhen) Co., Ltd., Shenzhen (CN)

(72) Inventors: BO TIAN, Shenzhen (CN); KANG WU, Shenzhen (CN)

(21) Appl. No.: 13/928,431

(22) Filed: Jun. 27, 2013

(30) Foreign Application Priority Data
Jun. 28, 2012 (CN) 2012102178387

(51) Int. Cl. G06F 1/26

(52) U.S. Cl. CPC G06F 1/26
USPC 713/300

(57) ABSTRACT

A power supply circuit for a hard disk backplane includes a first power input terminal, a second power input terminal, a first switch circuit, and a control voltage output terminal. The first and second power input terminals are configured to receive a first voltage and output the first voltage to supply power to a first hard disk drive group and a second hard disk drive group. The first switch circuit is coupled between the first power input terminal and the second power input terminal. The control voltage output terminal receives a control voltage to switch on or switch off the first switch circuit. When the first switch circuit is switched on, the first power input terminal is electronically connected to the second power input terminal, and when the first switch circuit is switched off, the first power input terminal is disconnected from the second power input terminal.

### BACKGROUND

1. Technical Field

The present disclosure relates to power supply technologies, and more particularly to a power supply circuit for a hard disk backplane and a server system using the same.

2. Description of Related Art

In server system, servers are usually placed in an enclosure. When one server is placed in the enclosure, all hard disk drives are supplied by the server. When two servers are placed in the enclosure, the hard disk drives are divided into two groups, and each group is supplied by one of the servers. In the above two conditions, because power supply circuits of a hard disk backplane are different, a single hard disk backplane cannot be used, which may bring inconvenience for users.

What is needed is to provide a means that can overcome the above-described limitations.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is a block diagram of a sever system including hard disk drive groups and a hard disk backplane.

FIG. 2 is a circuit diagram of a power supply circuit for the hard disk backplane of FIG. 1 according to a first embodiment of present disclosure.

FIG. 3 is a circuit diagram of a power supply circuit for a hard disk backplane according to a second embodiment of present disclosure.

FIG. 4 is a circuit diagram of a power supply circuit for a hard disk backplane according to a third embodiment of present disclosure.

FIG. 5 is a circuit diagram of a power supply circuit for a hard disk backplane according to a fourth embodiment of present disclosure.

### DETAILED DESCRIPTION

Reference will now be made to the drawings to describe certain exemplary embodiments of the present disclosure in detail.

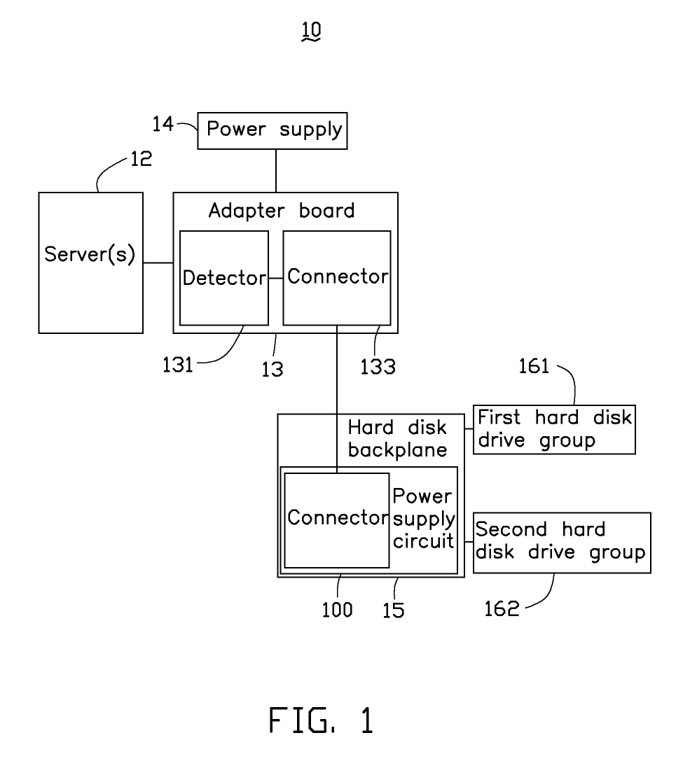

Referring to FIG. 1, a server system 10 includes at least one server 12, a adapter board 13, a power supply 14, a hard disk backplane 15, a first hard disk drive group 161 and a second hard disk drive group 162. The at least one server 12, the adapter board 13, the power supply 14, the hard disk backplane 15 and the hard disk drive groups 161 and 162 are placed in an enclosure of the server system 10. The server 12 is electronically coupled to the hard disk drive groups 161 and 162 via the adapter board 12 and the hard disk backplane 14 sequentially to control the hard disk drive groups 161 and 162.

The adapter board 13 includes a detector 131 and at least one connector 133. The detector 131 is configured to detect a number of the at least one server 12 electronically coupled to the adapter board 13 and control the at least one connector 133 to output a control voltage to the hard disk backplane 14 according to the detection. The at least one connector 133 may be electronically coupled to at least one connector of the hard disk backplane 15 via a cable and output a first voltage and a second voltage to supply power to the hard disk backplane 15.

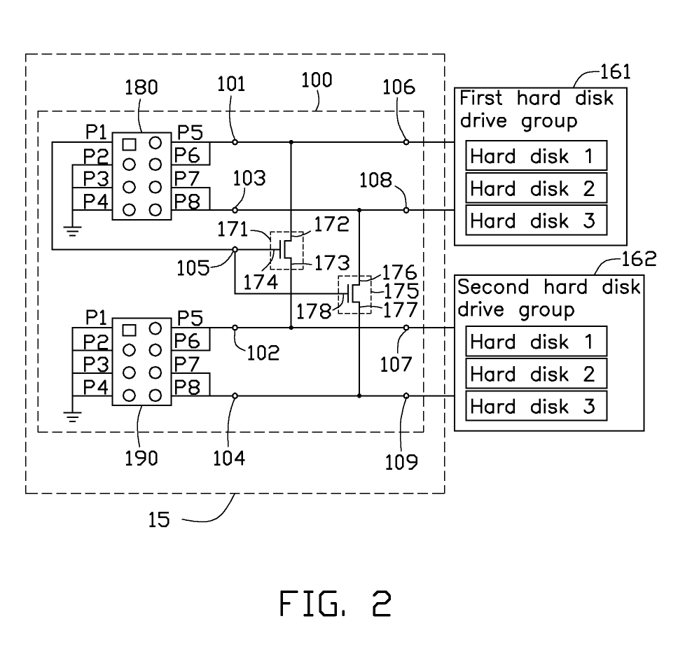

The power supply 14 is electronically coupled to the adapter board 13 to supply the at least one server 12 and the hard disk backplane 14 with power. Referring to FIG. 2, the hard disk backplane 14 includes a power supply circuit 100 configured to supply power to the first and the second hard disk drive groups 161 and 162. The power supply circuit 100 includes a first power input terminal 101, a second power input terminal 102, a third power input terminal 103, a fourth power input terminal 104, a control voltage output terminal 105, a first power output terminal 106, a second power output terminal 107, a third power output terminal 108, a fourth power output terminal 109, a first switch circuit 171, a second switch circuit 175, a first connector 180 and a second connector 190.

The first connector 180 and the second connector 190 are configured to receive the first voltage, the second voltage, and the control voltage from the adapter board 13. Each of the first connector 180 and the second connector 190 includes eight pins named as a first pin P1, a second pin P2, a third pin P3, a fourth pin P4, a fifth pin P5, a sixth pin P6, a seventh pin P7, and an eight pin P8. The first pin P1 of the first connector 180 is electronically connected to the control voltage output terminal 105 and is configured to receive the control voltage from the adapter board 13. The second, third and fourth pins P2, P3 and P4 of the first connector 180 are grounded. The fifth and sixth pins P5 and P6 of the first connector 180 are electronically connected to the first power input terminal 101 and are configured to receive the first voltage from the adapter board 13. The seventh and eight pins P7 and P8 of the first connector 180 are electronically connected to the third power input terminal 103 and are configured to receive the second voltage from the adapter board 13.

The first pin P1 of the second connector 190 is electronically connected to the control voltage output terminal 105 and is configured to receive the control voltage from the adapter board 13. The second, third and fourth pins P2, P3 and P4 of the second connector 190 are grounded. The fifth and sixth pins P5 and P6 of the second connector 190 are electronically connected to the second power input terminal 102 and are configured to receive the first voltage from the adapter board 13, and the seventh and eight pins P7 and P8 of the second connector 190 are electronically connected to the fourth power input terminal 104 and are configured to receive the second voltage from the adapter board 13.

The first power input terminal 101 receives the first voltage and outputs the first voltage to the first hard disk drive group 161 via the first power output terminal 106. The second power input terminal 102 receives the first voltage and outputs the first voltage to the second hard disk drive group 162 via the second power output terminal 107. The third power input terminal 102 receives the second voltage and outputs the second voltage to the first hard disk drive group 161 via the third power output terminal 108.

The fourth power input terminal 104 receives the second voltage and outputs the second voltage to the second hard disk drive group 162 via the fourth power output terminal 109.

The first switch circuit 171 is electronically coupled between the first power input terminal 101 and a second power input terminal 102. The first switch circuit 171 includes a first transistor, and the first transistor includes a first terminal 172 electronically coupled to the first power input terminal 101, a second terminal 173 electronically coupled to the second power input terminal 102, and a control terminal 174 electronically coupled to the control voltage output terminal 105. The second switch circuit 175 is electronically coupled between the third power input terminal 103 and a fourth power input terminal 104. The second switch circuit 175 includes a second transistor, and the second transistor includes a first terminal 176 electronically coupled to the third power input terminal 103, a second terminal 177 electronically coupled to the fourth power input terminal 104, and a control terminal 178 electronically coupled to the control voltage output terminal 105. The first voltage is 5 volts, and the second voltage is 12 volts.

The power supply circuit 100 is suitable for the server system 10 including two servers 11 and the server system 10 including only one server 11.

When two servers 11 are placed in the enclosure of the server system 10, the detector 131 controls the connector 131 to output a first control voltage to the hard disk backplane 14, such that the control terminal 105 receives the first control voltage to switch off the first switch circuit 171 and the second switch circuit 175 via the first connector 180. The first power input terminal 101 receives the first voltage from the adapter board 13 via the first connector 180 and provides the first voltage to supply power to the first hard disk drive group 161 via the first power output terminal 106. The second power input terminal 102 receives the first voltage from the adapter board 13 via the second connector 190 and provides the first voltage to supply power to the second hard disk drive group 162 via the second power output terminal 107. The third power input terminal 103 receives the second voltage from the adapter board 13 via the first connector 180 and provides the second voltage to supply power to the first hard disk drive group 161 via the third power output terminal 108. The fourth power input terminal 104 receives the second voltage from the adapter board 13 via the second connector 190 and provides the second voltage to supply power to the second hard disk drive group 162 via the fourth power output terminal 109. The first hard disk drive group 151 and the second hard disk drive group 153 are controlled by the two servers 11 respectively.

When only server 11 is placed in the enclosure of the server system 10, the detector 131 controls the connector 131 to output a second control voltage to the hard disk backplane 14, such that the control terminal 105 receives the second control voltage to switch on the first switch circuit 171 and the second switch circuit 175 via the first connector 180. The first switch circuit 171 and the second switch circuit 175 are switched on, the first power input terminal 101 and the second power input terminal 102 receive the first voltage together. The third power input terminal 103 and the fourth power input terminal 104 receive the second voltage together. When the first voltage is provided to at least one of the first power input terminal 101 and the second power input terminal 102 from the adapter board 13 via the first connector 180, and the second voltage is provided to at least one of third power input terminal 103 and the fourth power input terminal 104 from the adapter board 13 via the first connector 180, the first hard disk drive group 151 and the second hard disk drive group 153 are supplied with power.

According to the above description, the hard disk backplane 15 is suitable for a server system including one server or two servers, and that brings convenience for users.

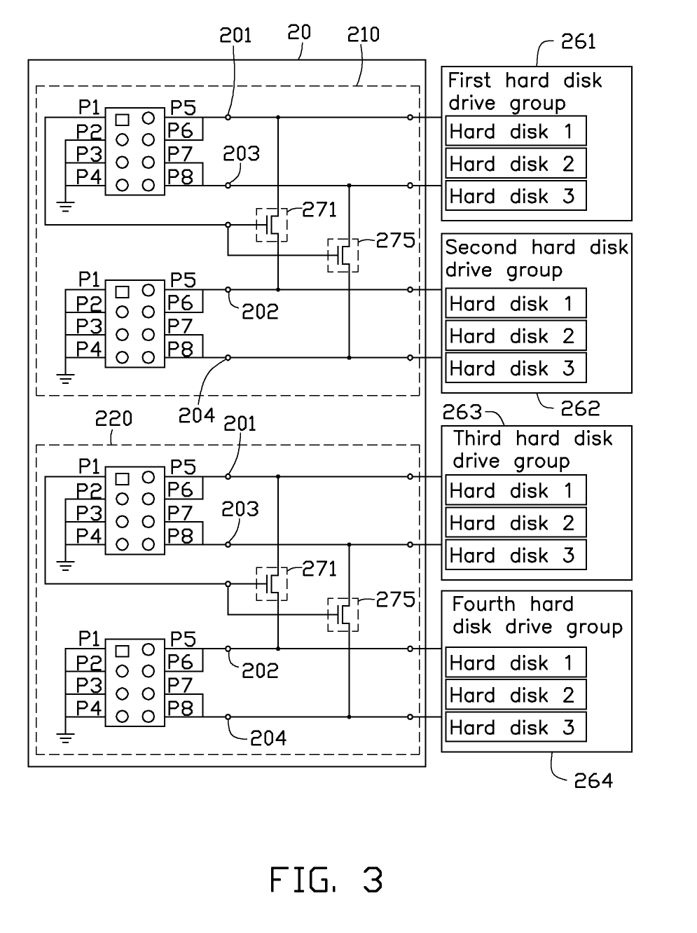

Referring to FIG. 3, a hard disk backplane 20 includes a first power supply circuit 210 and a second power supply circuit 220. The first power supply circuit 210 and the second power supply circuit 220 are on a printed circuit board (PCB) and are independent from each other. The hard disk backplane 20 is used for the server system including four servers and four hard disk drive groups, that is, the server system includes four servers and twelve hard disks, and the twelve hard disks are divided into four groups, named first hard disk drive group 261, second hard disk drive group 262, third hard disk drive group 263 and fourth hard disk drive group 264. Each of the first hard disk drive group 261, the second hard disk drive group 256, the third hard disk drive group 263 and the fourth hard disk drive group 264 includes three hard disks.

Each of the first power supply circuit 210 and the second power supply circuit 220 has the same structure as the power supply circuit 100 in FIG. 2. Details of the structure of the first power supply circuit 210 and the second power supply circuit 220 are not described here. The first power supply circuit 210 supplies power to the first hard disk drive group 261 and the second hard disk drive group 262. The second power supply circuit 220 supplies power to the third hard disk drive group 2263 and the fourth hard disk drive group 264.

When four servers are placed in the enclosure of the server system, each of the four servers electronically couples with a first hard disk drive group 261, a second hard disk drive group 262, a third hard disk drive group 263 and a fourth hard disk drive group 264 respectively, and the first hard disk drive group 261, the second hard disk drive group 262, the third hard disk drive group 263 and the fourth hard disk drive group 264 are controlled by each of the four servers respectively. When both of a first switch circuit 271 and a second switch circuit 275 are switched off, a first power input terminal 201 and a second power input terminal 202 receive a first voltage, and a third power input terminal 203 and a fourth power input terminal 204 receive a second voltage. Each of the four servers controls the first hard disk drive group 261, the second hard disk drive group 262, the third hard disk drive group 263 and the fourth hard disk drive group 264 independently.

When two servers are placed in the enclosure of the server system, one of the two servers controls the first hard disk drive group 261 and the second hard disk drive group 262 together, and the other server controls the third hard disk drive group 263 and the fourth hard disk drive group 264 together. The controlling principle of one server controlling the first hard disk drive group 261 and the second hard disk drive group 262, and the controlling principle of the other servers controlling the third hard disk drive group 263 and the fourth hard disk drive group 264 are same as the controlling principle of one server controlling the first hard disk drive group 151 and the second hard disk drive group 153 described above. Taking the first hard disk drive group 261 and the second hard disk drive group 262 controlled by one of the two servers as an example, the first switch circuit 271 and the second switch circuit 275 are switched on, the first power input terminal 201 and the second power input terminal 202 receive the first voltage together, and the third power input terminal 203 and the fourth power input terminal 204 receive the second voltage together. When the first voltage is provided to at least one of the power input terminal 201 and the second power input terminal 202, and the second voltage is provided to at least one of the third power input terminal 203 and the fourth power input terminal 204, the first hard disk drive group 261 and the second hard disk drive group 262 are thus supplied with power.

When three servers are placed in the enclosure of the server system, the first hard disk drive group 261 is controlled by a first server, the second hard disk drive group 262 is controlled by a second server, and the third hard disk drive group 263 and the fourth hard disk server 264 are controlled by a third server.

According to the above description, the hard disk backplane 20 is suitable for a server system including two servers, three servers, or four servers.

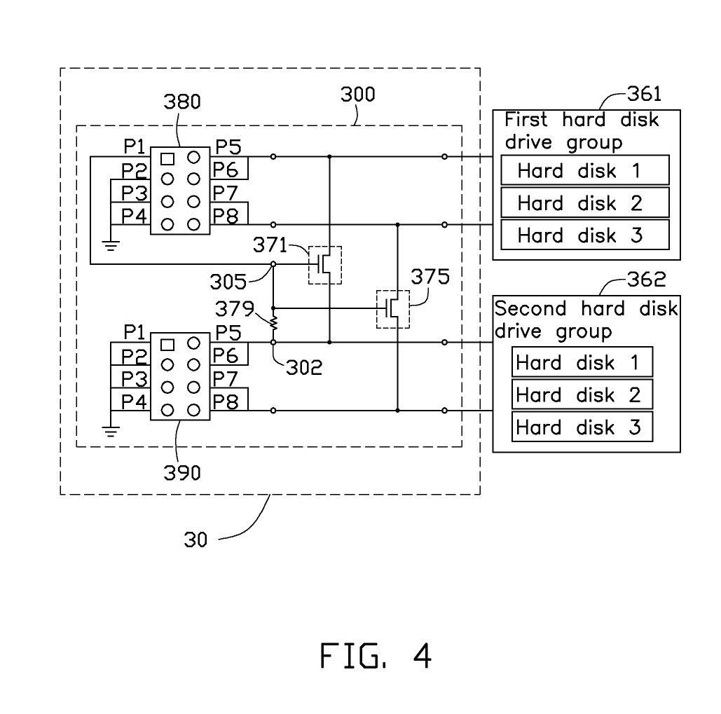

Referring to FIG. 4, a hard disk backplane 30 is similar to the above-described the hard disk backplane 15, differing in that a power supply circuit 30 further includes a resistor 379 electrically connected between a control terminal 305 and a second power input terminal 302.

When only server is placed in the enclosure of a server system, the first switch circuit 371 and the second switch circuit 375 are switched on by a first voltage from a first connector 380 or a first voltage from the resistor 379 and the second connector 390. That is, whichever connector of the first connector 380 and the second connector 390 is electrically connected to an adapter board, the first switch circuit 371 and the second switch circuit 375 are switched on by the control terminal 305, such that the hard disk backplane 30 can supply power to a first hard disk drive group 361 and a second hard disk drive group 362.

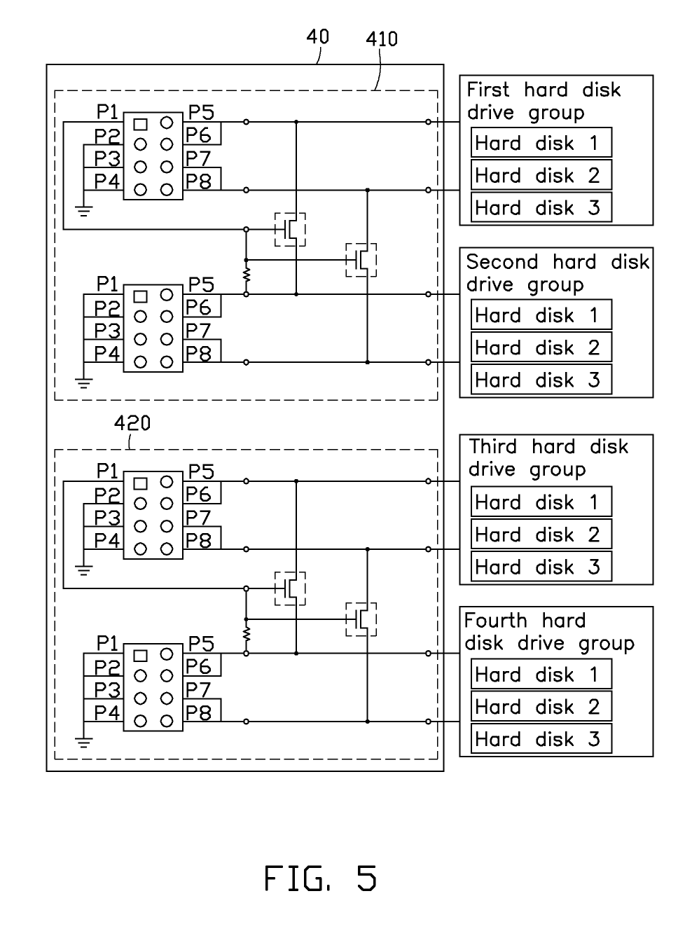

Referring to FIG. 5, a hard disk backplane 40 is similar to the above-described the hard disk backplane 30, differing in that the hard disk backplane 40 includes a first power supply circuit 410 and a second power supply circuit 420.

It is to be further understood that even though numerous characteristics and advantages of preferred and exemplary embodiments have been set out in the foregoing description, together with details of the structures and functions of the embodiments, the disclosure is illustrative only; and that changes may be made in detail, especially in matters of shape, size and arrangement of parts within the principles of the present disclosure to the full extent indicated by the broad general meaning of the terms in which the appended claims are expressed.

What is claimed is:

1. A power supply circuit for a hard disk backplane, comprising:
a first power input terminal receiving a first voltage and outputting the first voltage to supply power to a first hard disk drive group;
a second power input terminal receiving the first voltage and outputting the first voltage to supply power to a second hard disk drive group;
a first switch circuit electronically coupled between the first power input terminal and a second power input terminal; and
a control voltage output terminal receiving a control voltage and controlling the first switch circuit by the control voltage;
wherein when the first switch circuit is switched on, the first power input terminal is electronically connected to the second power input terminal, and when the first switch circuit is switched off, the first power input terminal is disconnected from the second power input terminal.

2. The power supply circuit according to claim 1, wherein the first switch circuit comprises a first transistor, the first transistor comprising:
a first terminal electronically coupled to the first power input terminal;
a second terminal electronically coupled to the second power input terminal; and
a control terminal electronically coupled to the control voltage output terminal.

3. The power supply circuit according to claim 2, further comprising a first connector, wherein the first connector comprises two pins, one pin of the two pins is connected a first power input terminal, a second pin of the two pins is connected the control voltage output terminal, the first connector is configured to electronically coupled to an adapter board to receive the first voltage and the control voltage, and the adapter board connected to at least one server.

4. The power supply circuit according to claim 3, further comprising a second connector, wherein the second connector comprises a pin connected a second power input terminal, the second connector is configured to electronically connect to the adapter board to receive the first voltage.

5. The power supply circuit according to claim 4, further comprising:
a third power input terminal receiving a second voltage and outputting the second voltage to supply power to the first hard disk drive group;
a fourth power input terminal receiving the second voltage and outputting the second voltage to supply power to the second hard disk drive group; and
a second switch circuit electronically coupled between the third power input terminal and a fourth power input terminal;
wherein when the second switch circuit is switched on, the third power input terminal is electronically connected to the fourth power input terminal, and when the second switch circuit is switched off, the third power input terminal is disconnected from the fourth power input terminal.

6. The power supply circuit according to claim 5, wherein the first connector further comprises six pins, the eight pins of the first connector are defined as a first pin, a second pin, a third pin, a fourth pin, a fifth pin, a sixth pin, a seventh pin, and an eight pin, the first pin of the first connector is electronically connected to the control voltage output terminal and is configured to receive the control voltage from the adapter board, the second, third and fourth pins of the first connector are grounded, the fifth and sixth pins of the first connector are electronically connected to the first power input terminal and are configured to receive the first voltage from the adapter board, and the seventh and eight pins of the first connector are electronically connected to the third power input terminal and are configured to receive the second voltage from the adapter board.

7. The power supply circuit according to claim 6, wherein the second connector further comprises seven pins, the eight pins of the second connector are defined as a first pin, a second pin, a third pin, a fourth pin, a fifth pin, a sixth pin, a seventh pin, and an eight pin, the first pin of the second connector is electronically connected to the control voltage output terminal and is configured to receive the control voltage from the adapter board, the second, third and fourth pins of the second connector are grounded, the fifth and sixth pins of the second connector are electronically connected to the second power input terminal and are configured to receive the first voltage from the adapter board, and the seventh and eight pins of the second connector are electronically connected to the fourth power input terminal and are configured to receive the second voltage from the adapter board.

8. The power supply circuit according to claim 7, wherein the first voltage is 5 volts, and the second voltage is 12 volts.

9. The power supply circuit according to claim 3, wherein the control voltage output terminal is also connected to the second power input terminal via a resistor.

10. A server system, comprising:
at least one server;
an adapter board electronically coupled to the at least one server;
a first hard disk drive group;
a second hard disk drive group;
a hard disk backplane electronically coupled to the adapter board and configured to supply the first hard disk drive group and the second hard disk drive group, the hard disk backplane comprising a power supply circuit, the power supply circuit comprising:
a first power input terminal receiving a first voltage and outputting the first voltage to supply power to the first hard disk drive group;
a second power input terminal receiving the first voltage and outputting the first voltage to supply power to the second hard disk drive group;
a first switch circuit electronically coupled between the first power input terminal and a second power input terminal; and
a control voltage output terminal for receiving a control voltage and controlling the first switch circuit by the control voltage;
wherein when the first switch circuit is switched on, the first power input terminal is electronically connected to the second power input terminal, and when the first switch circuit is switched off, the first power input terminal is disconnected from the second power input terminal.

11. The server system according to claim 10 wherein the first switch circuit comprises a first transistor, the first transistor comprising:
a first terminal electronically coupled to the first power input terminal;
a second terminal electronically coupled to the second power input terminal; and
a control terminal electronically coupled to the control voltage output terminal.

12. The server system according to claim 11, wherein the power supply circuit further comprises a first connector, the first connector comprises two pins, one pin of the two pins is connected a first power input terminal, the other one pin is connected the control voltage output terminal, the first connector is configured to electronically coupled to an adapter board to receive the first voltage and the control voltage, and the adapter board connected to at least one server.

13. The server system according to claim 12, wherein the power supply circuit further comprises a second connector, the second connector comprises a pin connected a second power input terminal, the second connector is configured to electronically connect to the adapter board to receive the first voltage.

14. The server system according to claim 13, wherein the power supply circuit further comprises:
a third power input terminal receiving a second voltage and outputting the second voltage to supply power to the first hard disk drive group;
a fourth power input terminal receiving the second voltage and outputting the second voltage to supply power to the second hard disk drive group; and
a second switch circuit electronically coupled between the third power input terminal and a fourth power input terminal;
wherein when the second switch circuit is switched on, the third power input terminal is electronically connected to the fourth power input terminal, and when the second switch circuit is switched off, the third power input terminal is disconnected from the fourth power input terminal.

15. The server system according to claim 14, wherein the first connector further comprises six pins, the eight pins of the first connector are defined as a first pin, a second pin, a third pin, a fourth pin, a fifth pin, a sixth pin, a seventh pin, and an eight pin, the first pin of the first connector is electronically connected to the control voltage output terminal and is configured to receive the control voltage from the adapter board, the second, third and fourth pins of the first connector are grounded, the fifth and sixth pins of the first connector are electronically connected to the first power input terminal and are configured to receive the first voltage from the adapter board, and the seventh and eight pins of the first connector are electronically connected to the third power input terminal and are configured to receive the second voltage from the adapter board.

16. The server system according to claim 15, wherein the second connector further comprises seven pins, the eight pins of the second connector are defined as a first pin, a second pin, a third pin, a fourth pin, a fifth pin, a sixth pin, a seventh pin, and an eight pin, the first pin of the second connector is electronically connected to the control voltage output terminal and is configured to receive the control voltage from the adapter board, the second, third and fourth pins of the second connector are grounded, the fifth and sixth pins of the second connector are electronically connected to the second power input terminal and are configured to receive the first voltage from the adapter board, and the seventh and eight pins of the second connector are electronically connected to the fourth power input terminal and are configured to receive the second voltage from the adapter board.

17. The server system according to claim 16, wherein the first voltage is 5 volts, and the second voltage is 12 volts.

18. The server system according to claim 12, wherein the adapter board comprises a detector configured to detect the number of the servers connected to the adapter board and control the adapter board to output the control voltage according to the detecting result, when two servers are connected to the adapter board, the detector controls the adapter board to output the control voltage to switch off the first switch circuit, when only one serve is connected to the adapter board, the detector controls the adapter board to output the control voltage to switch on the first switch circuit.

19. The server system according to claim 12, wherein the control voltage output terminal is also connected to the second power input terminal via a resistor.
